(19) United States
(12) Patent Application Publication
(10) Pub. No.: US 2026/0278815 A1
(43) Pub. Date: Sep. 17, 2026

(54) THREE-DIMENSIONAL (3D) TO TWO-DIMENSIONAL (2D) BOUNDING BOX ALIGNMENT

(71) Applicant: QUALCOMM Incorporated, San Diego, CA (US)

(72) Inventors: Shashwata GUPTA, Kolkata (IN); Ashish GARG, Pehowa (IN); Varun RAVI KUMAR, San Diego, CA (US); Senthil Kumar YOGAMANI, San Diego, CA (US)

(21) Appl. No.: 19/082,103

(22) Filed: Mar. 17, 2025

(51) Int. Cl. G06T 7/33

(52) U.S. Cl. CPC G06T 7/33; G06T 2207/10028

(57) ABSTRACT

Systems and techniques are described herein for three-dimensional (3D) to two-dimensional (2D) alignment. For instance, a process can include projecting a 3D point in 3D data obtained from a first sensor to a projected 2D point based on a set of projection parameters; determining a filtered estimated set of projection parameters and a variance value for projecting the 3D point to the projected 2D point based on a comparison between the projected 2D point and a 2D point obtained based on 2D data from a second sensor; performing cross-attention between the filtered estimated set of projection parameters, projected 2D point, and variance value to determine a distribution for the projected 2D point; and outputting the projected 2D point and distribution for the projected 2D point.

### FIELD

Aspects of the present disclosure are related to systems and techniques for a robust 3D to 2D bounding box alignment (e.g., with uncertainty aware multi-sensor fusion).

### BACKGROUND

Increasingly, systems and devices (e.g., autonomous vehicles, such as autonomous and semi-autonomous cars, drones, mobile robots, mobile devices, extended reality (XR) devices, and other suitable systems or devices) include multiple sensors to gather information about the environment, as well as processing systems to process the information gathered, such as for route planning, navigation, collision avoidance, environment modelling/rendering, etc. One example of such a system is a localization system for XR devices and/or Advanced Driver Assistance System (ADAS) for a vehicle. In such systems, sensor data, such as images captured from one or more cameras, may be gathered, transformed, and analyzed to detect objects in the sensor data using Machine learning (ML) models.

Machine learning (ML) models, such as a neural network (NN) may include multiple layers of interconnected nodes (e.g., neurons). Each node may include various parameters, such as weights and/or bias values, that may be applied to the nodes, along with an activation function to determine whether a node may be used (e.g., activated). These parameters and activation functions may be tuned during training of the ML model to perform various tasks, such as feature/object detection, recognition, etc. In some cases, a ML model may include many millions of nodes along with the associated parameters and activation functions.

In some cases, sensor information may be gathered from multiple types of sensors, such as lidar, radar, camera, and the like, and fused (e.g., combined) to provide a more accurate and/or comprehensive representation of an environment, for example, around a device. Sensor fusion may operate based on calibrated sensors where various properties of the sensors are known, such as camera intrinsic and extrinsic information, locations of the various sensors with respect to each other, and the like. In real-world operations, precise calibration and/or alignment cannot be assumed. Thus, techniques for compensating for uncertainty in sensor data may be useful.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

In one illustrative example, an apparatus for three-dimensional (3D) to two-dimensional (2D) alignment is provided. The apparatus include: at least one memory, and at least one processor coupled to the at least one memory and configured to: project a 3D point in 3D data obtained from a first sensor to a projected 2D point based on a set of projection parameters; determine a filtered estimated set of projection parameters and a variance value for projecting the 3D point to the projected 2D point based on a comparison between the projected 2D point and a 2D point obtained based on 2D data from a second sensor; perform cross-attention between the filtered estimated set of projection parameters, projected 2D point, and variance value to determine a distribution for the projected 2D point; and output the projected 2D point and distribution for the projected 2D point.

As another example, method for three-dimensional (3D) to two-dimensional (2D) alignment is provided. The method includes: projecting a 3D point in 3D data obtained from a first sensor to a projected 2D point based on a set of projection parameters; determining a filtered estimated set of projection parameters and a variance value for projecting the 3D point to the projected 2D point based on a comparison between the projected 2D point and a 2D point obtained based on 2D data from a second sensor; performing cross-attention between the filtered estimated set of projection parameters, projected 2D point, and variance value to determine a distribution for the projected 2D point; and outputting the projected 2D point and distribution for the projected 2D point.

In another example, a non-transitory computer-readable medium having stored thereon instructions is provided. The instructions, when executed by at least one processor, cause the at least one processor to: project a 3D point in 3D data obtained from a first sensor to a projected 2D point based on a set of projection parameters; determine a filtered estimated set of projection parameters and a variance value for projecting the 3D point to the projected 2D point based on a comparison between the projected 2D point and a 2D point obtained based on 2D data from a second sensor; perform cross-attention between the filtered estimated set of projection parameters, projected 2D point, and variance value to determine a distribution for the projected 2D point; and output the projected 2D point and distribution for the projected 2D point.

For another example, an apparatus for three-dimensional (3D) to two-dimensional (2D) alignment is provided. The apparatus includes: means for projecting a 3D point in 3D data obtained from a first sensor to a projected 2D point based on a set of projection parameters; means for determining a filtered estimated set of projection parameters and a variance value for projecting the 3D point to the projected 2D point based on a comparison between the projected 2D point and a 2D point obtained based on 2D data from a second sensor; means for performing cross-attention between the filtered estimated set of projection parameters, projected 2D point, and variance value to determine a distribution for the projected 2D point; and means for outputting the projected 2D point and distribution for the projected 2D point.

In some aspects, one or more of the apparatuses described herein comprises a mobile device (e.g., a mobile telephone or so-called “smart phone”, a tablet computer, or other type of mobile device), a wearable device, an extended reality device (e.g., a virtual reality (VR) device, an augmented reality (AR) device, or a mixed reality (MR) device), a personal computer, a laptop computer, a video server, a television (e.g., a network-connected television), a vehicle (or a computing device of a vehicle), or other device. In some aspects, the apparatus(es) includes at least one camera for capturing one or more images or video frames. For example, the apparatus(es) can include a camera (e.g., an RGB camera) or multiple cameras for capturing one or more images and/or one or more videos including video frames. In some aspects, the apparatus(es) includes at least one display for displaying one or more images, videos, notifications, or other displayable data. In some aspects, the apparatus(es) includes at least one transmitter configured to transmit one or more video frame and/or syntax data over a transmission medium to at least one device. In some aspects, the at least one processor includes a neural processing unit (NPU), a neural signal processor (NSP), a central processing unit (CPU), a graphics processing unit (GPU), any combination thereof, and/or other processing device or component.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIG. 1 illustrates an example implementation of a system-on-a-chip (SOC), in accordance with some examples;

FIG. 2 is a block diagram illustrating an example of a deep learning neural network, according to some aspects of the present disclosure;

FIG. 3 is a block diagram illustrating an example of a convolutional neural network (CNN), according to various aspects of the present disclosure;

FIG. 4 is a block diagram illustrating an example of a deep convolutional network, in accordance with aspects of the present disclosure;

FIG. 5 illustrates a technique for generating BEV features, in accordance with aspects of the present disclosure;

FIG. 6A illustrates examples of particles, in accordance with aspects of the present disclosure;

FIG. 6B illustrates an example of interactions between bounding boxes and particles, in accordance with aspects of the present disclosure;

FIG. 7 illustrates an example of particle filtering, in accordance with aspects of the present disclosure.

FIG. 8 illustrates an example of a distribution for a 2D projected point 800, in accordance with aspects of the present disclosure;

FIG. 9 is a flow diagram illustrating a process for 3D to 2D projection, in accordance with aspects of the present disclosure; and

FIG. 10 illustrates an example computing device architecture of an example computing device which can implement the various techniques described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the application as set forth in the appended claims.

Devices or systems (e.g., autonomous vehicles, such as autonomous and semi-autonomous vehicles, drones or unmanned aerial vehicles (UAVs), mobile robots, mobile devices such as mobile phones, extended reality (XR) devices, and other suitable devices or systems) include multiple sensors to gather information about an environment, as well as processing systems to process the sensor information for various purposes, such as route planning, navigation, collision avoidance, etc. One example of a processing system is an Advanced Driver Assistance System (ADAS) for an autonomous or semi-autonomous vehicle. To enable analysis of the sensor data, the data from multiple sensors may be fused into a single view or model of an environment around the autonomous vehicle. In some cases, data from certain sensors may be projected from 3D to 2D to allow the data to be aligned and fused. In some cases, the alignment may be performed based on precise sensor calibrations. In real world applications, maintaining a precise sensor calibration for multiple sensors on a device can be challenging. For example, devices with sensors may be vulnerable to sensor/calibration drift, sensor inaccuracy, noise, physically relocated sensors, and the like, which may result in unreliable 3D to 2D bounding box alignments between a projected 2D bounding box and a bounding box from 2D object detection, especially in complex environments. Thus, techniques for dynamically updating calibrations as between sensors may be useful.

Systems, apparatuses, electronic devices, methods (also referred to as processes), and computer-readable media (collectively referred to herein as “systems and techniques”) are described herein for 3D to 2D alignment. For example, one or more 3D points may be obtained, for example, from 3D features generated based on 3D sensor data, such as data from a lidar sensor. The one or more 3D points may be based on a 3D bounding box. For example, 3D object detection may be performed based on the 3D features to generate the 3D bounding box. Similarly, one or more 2D points may be generated based on 2D data, such as an image. The one or more 2D points may be based on a 2D bounding box and the 2D bounding box may be generated based on an object detected in the 2D data. In some cases, a 3D point may be projected to a projected 2D point based on a set of projection parameters. In some cases, the set of projection parameters may be represented by a particle, of a set of particles. The projected 2D point may be compared to the 2D point generated based on the 2D data. The comparison may be used to determine a projection loss and this projection loss may be used to update a weight associated with the set of projection parameters (e.g., associated with the particle). In some cases, this projection loss may be an intersection over union (IoU) between the projected 2D point and the 2D point obtained based on 2D data.

The set of projection parameters may be resampled based on the weight to determine a filtered estimated set of projection parameters and a variance for projecting the 3D point to the projected 2D point. In some cases, the set of projection parameters may be resampled based on a second set of projection parameters (e.g., second particle), where the second set of projection parameters is associated with a larger weight as compared the set of projection parameters.

In some cases, cross-attention may be performed on the filtered estimated set of projection parameters, projected 2D point, and variance value to determine a distribution for the projected 2D point. In some cases, the cross-attention may be performed based on a Gaussian distribution around the projected 2D point based on the variance value. The cross-attention may weigh (e.g., apply a weight) the projected 2D point based on the variance value. The projected 2D point and distribution for the projected 2D point may be output. Various aspects of the present disclosure will be described with respect to the figures.

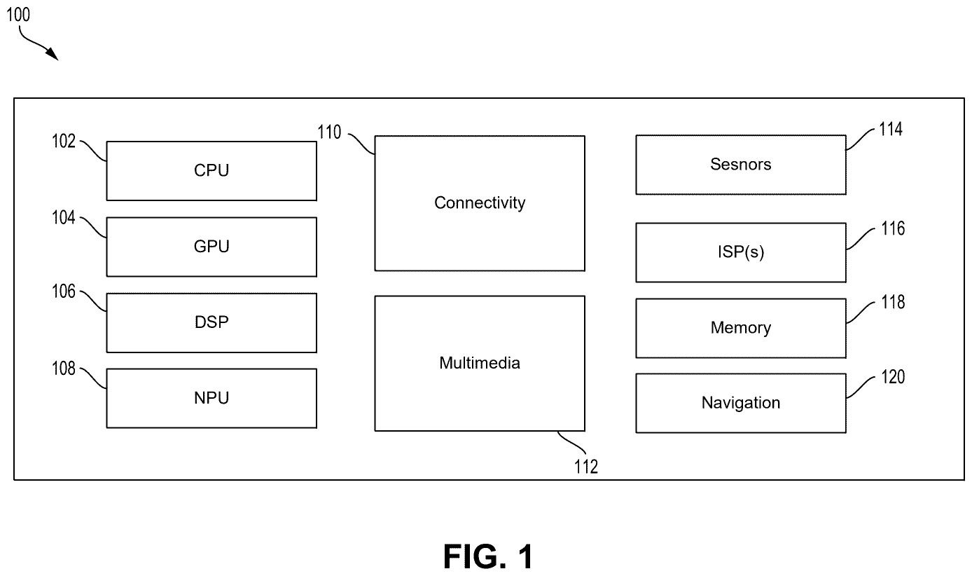

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. SOC 100 and/or components thereof may be configured to perform segmentation mask extrapolation. For example, the CPU 102, DSP 106, and/or GPU 104 may be configured to perform object detection using a visual language model via latent feature adaptation with synthetic data.

In some cases, the SOC 100 may process data using neural networks and/or machine learning (ML) systems. A neural network is an example of an ML system, and a neural network can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

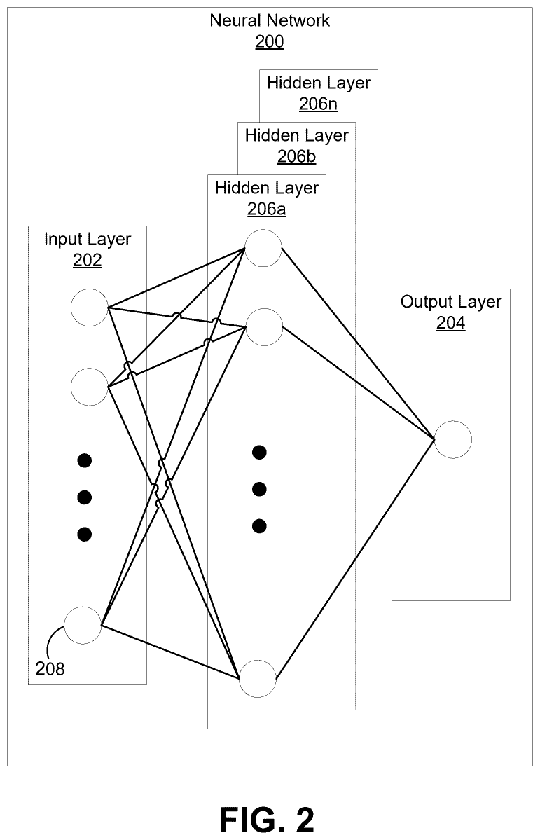

FIG. 2 is an illustrative example of a neural network 200 (e.g., a deep-learning neural network) that can be used to implement machine-learning-based image generation, feature segmentation, implicit-neural-representation generation, rendering, classification, object detection, image recognition (e.g., face recognition, object recognition, scene recognition, etc.), feature extraction, authentication, gaze detection, gaze prediction, and/or automation. The neural network 200 may be run, for example, on one or more processors, such as CPU 102 of FIG. 1, GPU 104 of FIG. 1, DSP 106 of FIG. 1, NPU 108 of FIG. 1, etc.

An input layer 202 includes input data. Neural network 200 includes multiple hidden layers hidden layers 206a, 206b, through 206n. The hidden layers 206a, 206b, through hidden layer 206n include “n” number of hidden layers, where “n” is an integer greater than or equal to one. The number of hidden layers can be made to include as many layers as needed for the given application. Neural network 200 further includes an output layer 204 that provides an output resulting from the processing performed by the hidden layers 206a, 206b, through 206n.

Neural network 200 may be, or may include, a multi-layer neural network of interconnected nodes. Each node can represent a piece of information. Information associated with the nodes is shared among the different layers and each layer retains information as information is processed. In some cases, neural network 200 can include a feed-forward network, in which case there are no feedback connections where outputs of the network are fed back into itself. In some cases, neural network 200 can include a recurrent neural network, which can have loops that allow information to be carried across nodes while reading in input.

Information can be exchanged between nodes through node-to-node interconnections between the various layers. Nodes of input layer 202 can activate a set of nodes in the first hidden layer 206a. For example, as shown, each of the input nodes of input layer 202 is connected to each of the nodes of the first hidden layer 206a. The nodes of first hidden layer 206a can transform the information of each input node by applying activation functions to the input node information. The information derived from the transformation can then be passed to and can activate the nodes of the next hidden layer 206b, which can perform their own designated functions. Example functions include convolutional, up-sampling, data transformation, and/or any other suitable functions. The output of the hidden layer 206b can then activate nodes of the next hidden layer, and so on. The output of the last hidden layer 206n can activate one or more nodes of the output layer 204, at which an output is provided. In some cases, while nodes (e.g., node 208) in neural network 200 are shown as having multiple output lines, a node has a single output and all lines shown as being output from a node represent the same output value.

In some cases, each node or interconnection between nodes can have a weight that is a set of parameters derived from the training of neural network 200. Once neural network 200 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 200 to be adaptive to inputs and able to learn as more and more data is processed.

Neural network 200 may be pre-trained to process the features from the data in the input layer 202 using the different hidden layers 206a, 206b, through 206n in order to provide the output through the output layer 204. In an example in which neural network 200 is used to identify features in images, neural network 200 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 200 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training images until neural network 200 is trained well enough so that the weights of the layers are accurately tuned.

For the example of identifying objects in images, the forward pass can include passing a training image through neural network 200. The weights are initially randomized before neural network 200 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 200, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 200 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as

$${E}_{total} = \sum \frac{1}{2} {( target - output )}^{2} .$$

The loss can be set to be equal to the value of Etotal.

The loss (or error) will be high for the first training images since the actual values will be much different than the predicted output. The goal of training is to minimize the amount of loss so that the predicted output is the same as the training label. Neural network 200 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{dL}{dW} ,$$

where w denotes a weight, wi denotes the initial weight, and η denotes a learning rate. The learning rate can be set to any suitable value, with a high learning rate including larger weight updates and a lower value indicating smaller weight updates.

Neural network 200 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 200 can include any other deep network other than a CNN, such as an autoencoder, a deep belief nets (DBNs), a Recurrent Neural Networks (RNNs), among others.

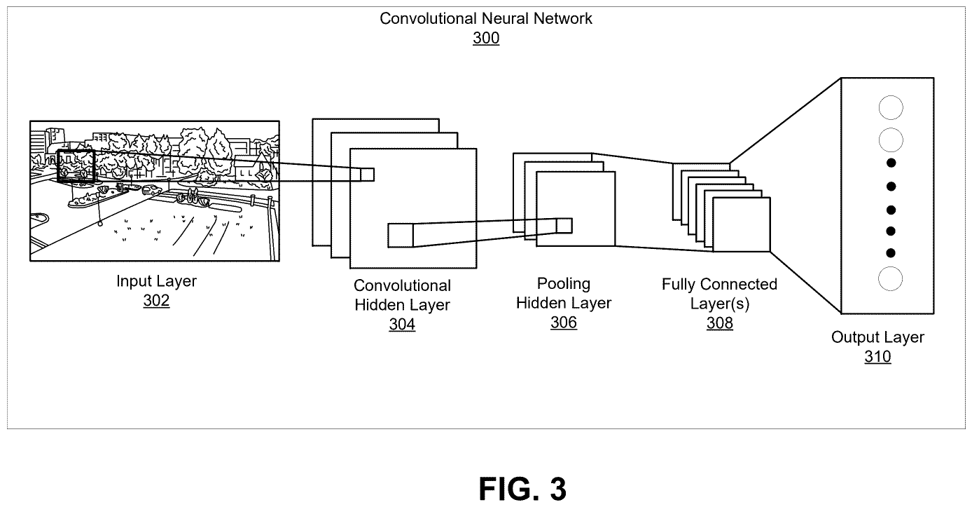

FIG. 3 is an illustrative example of a convolutional neural network (CNN) 300. The input layer 302 of the CNN 300 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 304, an optional non-linear activation layer, a pooling hidden layer 306, and fully connected layer 308 (which fully connected layer 308 can be hidden) to get an output at the output layer 310. While only one of each hidden layer is shown in FIG. 3, one of ordinary skill will appreciate that multiple convolutional hidden layers, non-linear layers, pooling hidden layers, and/or fully connected layers can be included in the CNN 300. As previously described, the output can indicate a single class of an object or can include a probability of classes that best describe the object in the image.

The first layer of the CNN 300 can be the convolutional hidden layer 304. The convolutional hidden layer 304 can analyze image data of the input layer 302. Each node of the convolutional hidden layer 304 is connected to a region of nodes (pixels) of the input image called a receptive field. The convolutional hidden layer 304 can be considered as one or more filters (each filter corresponding to a different activation or feature map), with each convolutional iteration of a filter being a node or neuron of the convolutional hidden layer 304. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 304. Each connection between a node and a receptive field for that node learns a weight and, in some cases, an overall bias such that each node learns to analyze its particular local receptive field in the input image. Each node of the convolutional hidden layer 304 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 304 is due to each node of the convolutional layer being applied to its corresponding receptive field. For example, a filter of the convolutional hidden layer 304 can begin in the top-left corner of the input image array and can convolve around the input image. As noted above, each convolutional iteration of the filter can be considered a node or neuron of the convolutional hidden layer 304. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 304. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 304.

The mapping from the input layer to the convolutional hidden layer 304 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 304 can include several activation maps in order to identify multiple features in an image. The example shown in FIG. 3 includes three activation maps. Using three activation maps, the convolutional hidden layer 304 can detect three different kinds of features, with each feature being detectable across the entire image.

In some examples, a non-linear hidden layer can be applied after the convolutional hidden layer 304. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 300 without affecting the receptive fields of the convolutional hidden layer 304.

The pooling hidden layer 306 can be applied after the convolutional hidden layer 304 (and after the non-linear hidden layer when used). The pooling hidden layer 306 is used to simplify the information in the output from the convolutional hidden layer 304. For example, the pooling hidden layer 306 can take each activation map output from the convolutional hidden layer 304 and generates a condensed activation map (or feature map) using a pooling function. Max-pooling is one example of a function performed by a pooling hidden layer. Other forms of pooling functions be used by the pooling hidden layer 306, such as average pooling, L2-norm pooling, or other suitable pooling functions. A pooling function (e.g., a max-pooling filter, an L2-norm filter, or other suitable pooling filter) is applied to each activation map included in the convolutional hidden layer 304. In the example shown in FIG. 3, three pooling filters are used for the three activation maps in the convolutional hidden layer 304.

In some examples, max-pooling can be used by applying a max-pooling filter (e.g., having a size of 2×2) with a stride (e.g., equal to a dimension of the filter, such as a stride of 2) to an activation map output from the convolutional hidden layer 304. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 304 having a dimension of 24×24 nodes, the output from the pooling hidden layer 306 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 300.

The final layer of connections in the network is a fully-connected layer that connects every node from the pooling hidden layer 306 to every one of the output nodes in the output layer 310. Using the example above, the input layer includes 28×28 nodes encoding the pixel intensities of the input image, the convolutional hidden layer 304 includes 3×24×24 hidden feature nodes based on application of a 5×5 local receptive field (for the filters) to three activation maps, and the pooling hidden layer 306 includes a layer of 3×12×12 hidden feature nodes based on application of max-pooling filter to 2×2 regions across each of the three feature maps. Extending this example, the output layer 310 can include ten output nodes. In such an example, every node of the 3×12×12 pooling hidden layer 306 is connected to every node of the output layer 310.

The fully connected layer 308 can obtain the output of the previous pooling hidden layer 306 (which should represent the activation maps of high-level features) and determines the features that most correlate to a particular class. For example, the fully connected layer 308 can determine the high-level features that most strongly correlate to a particular class and can include weights (nodes) for the high-level features. A product can be computed between the weights of the fully connected layer 308 and the pooling hidden layer 306 to obtain probabilities for the different classes. For example, if the CNN 300 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 310 can include an M-dimensional vector (in the prior example, M=10). M indicates the number of classes that the CNN 300 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

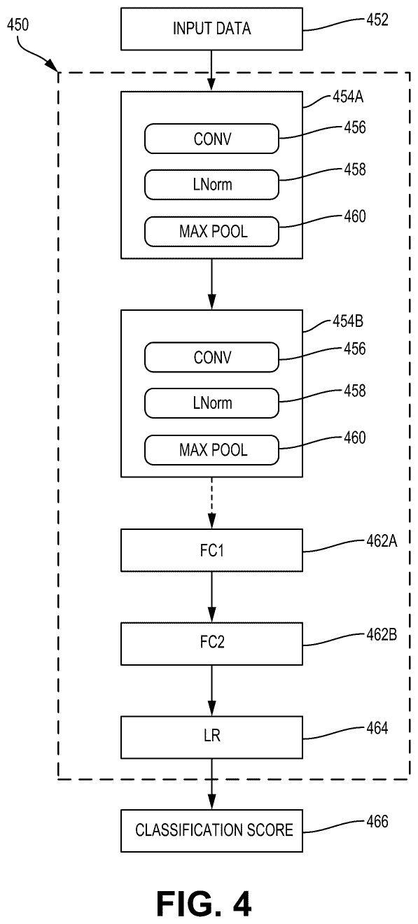

FIG. 4 is a block diagram illustrating an example of a deep convolutional network 450. The deep convolutional network 450 may include multiple different types of layers based on connectivity and weight sharing. As shown in FIG. 4, the deep convolutional network 450 includes the convolution blocks 454A, 454B. Each of the convolution blocks 454A, 454B may be configured with a convolution layer (CONV) 456, a normalization layer (LNorm) 458, and a max pooling layer (MAX POOL) 460. Of note, the layers illustrated with respect to convolution blocks 454A and 454B are examples of layers that may be included in a convolution layer and are not intended to be limiting and other types of layers may be included in any order.

The convolution layers 456 may include one or more convolutional filters, which may be applied to the input data 452 to generate a feature map. Although only two convolution blocks 454A, 454B are shown, the present disclosure is not so limiting, and instead, any number of convolution blocks (e.g., convolution blocks 454A, 454B) may be included in the deep convolutional network 450 according to design preference. The normalization layer 458 may normalize the output of the convolution filters. For example, the normalization layer 458 may provide whitening or lateral inhibition. The max pooling layer 460 may provide down sampling aggregation over space for local invariance and dimensionality reduction.

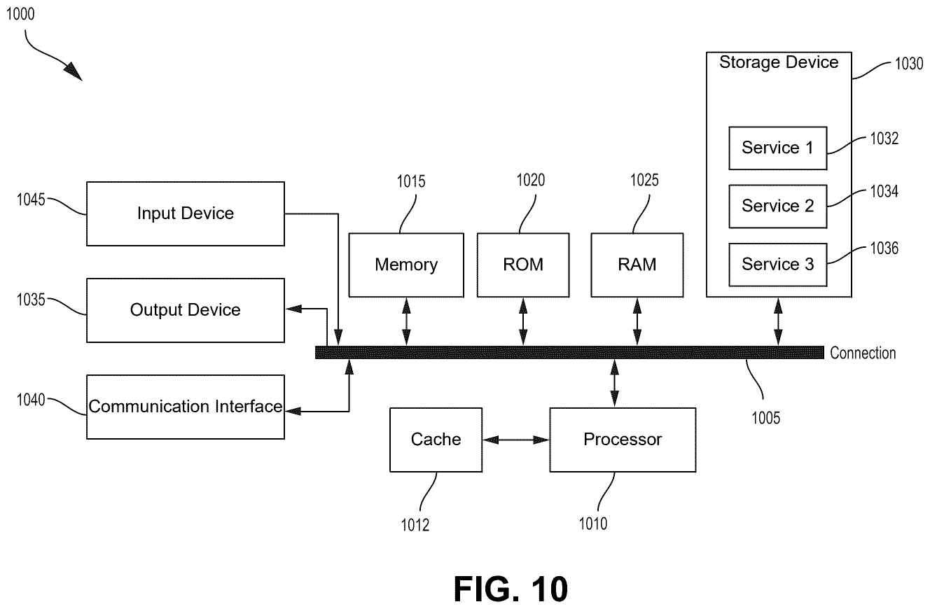

The parallel filter banks, for example, of a deep convolutional network may be loaded on a processor such as a CPU or GPU, or any other type of processor 1010 discussed with respect to the computing device architecture 1000 of FIG. 10 to achieve high performance and low power consumption. In alternative aspects, the parallel filter banks may be loaded on a DSP or an ISP of the computing device architecture 1000 of FIG. 10. In addition, the deep convolutional network 450 may access other processing blocks that may be present on the computing device architecture 1000 of FIG. 10, such as sensor processor and navigation module, dedicated, respectively, to sensors and navigation.

The deep convolutional network 450 may also include one or more fully connected layers, such as layer 462A (labeled “FC1”) and layer 462B (labeled “FC2”). The deep convolutional network 450 may further include a logistic regression (LR) layer 464. Between each layer 456, 458, 460, 462A, 462B, 464 of the deep convolutional network 450 are weights (not shown) that are to be updated. The output of each of the layers (e.g., 456, 458, 460, 462A, 462B, 464) may serve as an input of a succeeding one of the layers (e.g., 456, 458, 460, 462A, 462B, 464) in the deep convolutional network 450 to learn hierarchical feature representations from input data 452 (e.g., images, audio, video, sensor data and/or other input data) supplied at the first of the convolution blocks 454A. The output of the deep convolutional network 450 is a classification score 466 for the input data 452. The classification score 466 may be a set of probabilities, where each probability is the probability of the input data including a feature from a set of features.

In some cases, one or more convolutional networks, such as a DCN, may be incorporated into more complex ML networks. As an example, as indicated above, the deep convolutional network 350 may output probabilities that an input data, such as an image, includes certain features. The deep convolutional network 450 may then be modified to extract (e.g., output) certain features. Additionally, DCNs may be added to extract other features as well. This set of DCNs may function as feature extractors to identify features in an image. In some cases, feature extractors may be used as a backbone for additionally ML network components to perform further operations, such as image segmentation.

In some cases, cross-attention blocks may be used for a variety of applications where complex, non-linear relationships may be learned, such as for language-based tasks. For example, cross-attention blocks may be used in large language models. A cross-attention block may be used in a ML model that can learn context about features to try to detect relationships between sequences of in data to focus on relevant information of a sequence of data while processing another sequence of data. Cross-attention blocks may be inserted into other ML models, such as deep convolutional network 450 of FIG. 4, CNN 300 of FIG. 3, neural network 200 of FIG. 2, etc.

In some cases, one or more convolutional networks, such as a DCN, may be incorporated into more complex ML networks. As an example, as indicated above, the deep convolutional network 450 may output probabilities that an input data, such as an image, includes certain features. The deep convolutional network 450 may then be modified to extract (e.g., output) certain features. Additionally, DCNs may be added to extract other features as well. This set of DCNs may function as feature extractors to identify features in an image. In some cases, feature extractors may be used as a backbone for additional ML network components to perform further operations, such as localization, image segmentation, object detection, etc.

In some cases, the extracted features and images may be used to construct a three-dimensional (3D) bird's eye view (BEV) (e.g., a top-down view) multimodal feature map of an environment. For example, an XR device and/or ADAS system may include a suite of sensors that may sense the environment using different techniques. Multimodal features may be generated based on data from multiple different types of sensors, such as an image sensor along with at least one other type of sensor, such as a LIDAR, RADAR, SODAR, SONAR, etc. Using different sensor types helps provide a more holistic understanding of the environment, increases robustness against failure and/or noise from a single sensor modality, and may help overcome occlusions. In some cases, a sensor type of a sensor may be based on how the sensor senses the environment. For example, two sensors which sense different parts of the electromagnetic spectrum may have different sensor types. Similarly, a sensor which senses reflection/refraction of projected light may have a different sensor type from another sensor which senses natural reflected/refracted light. In some cases, the different sensors may sense the environment in three dimensions. The multimodal features may be transformed into 3D BEV features to help provide a viewpoint invariant representation that encodes semantic information about the environment. In some cases, the 3D BEV features may be normalized based on sensor configuration to help enable generalizability of the multimodal 3D BEV features across systems with different sensors.

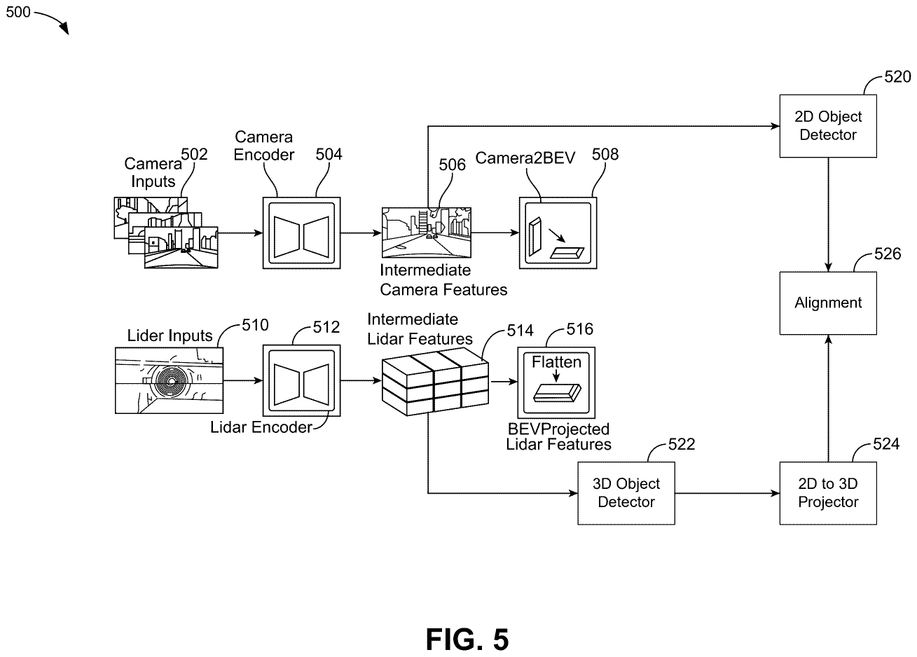

FIG. 5 illustrates a technique 500 for generating BEV features, in accordance with aspects of the present disclosure. In technique 500, input camera data 502 (e.g., images captured by cameras) may be input to a camera data encoder 504. The camera data encoder 504 may include one or feature extractors. These feature extractors may be ML based and be used to identify certain features in the camera data. As an example, the feature extractors may include one or more layers or transformer blocks which may include feature maps for recognizing certain features. The camera data encoder 504 may output the identified features as intermediate camera features 506. Of note, the input camera data 502 and camera data encoder 504 may operate in a 2D space (e.g., on a height and width axes with respect to the camera). A perspective transformation may be applied to the output intermediate camera features 508 which converts the intermediate camera features from, for example, a frontal view of an environment from a vehicle to BEV projected camera features 508 as if features were generated based on a camera positioned above the vehicle. In some cases, the perspective transformation may be ML based.

In some cases, the intermediate camera features 506 may be input to a 2D object detector 520 for object detection. In some cases, the 2D object detector 520 may be ML based and the 2D object detector may locate and identify objects that are imaged in the input camera data 502. For example, the 2D object detector 520 may detect and/or identify objects and place a bounding box around detected objects. The 2D object detector 520 may output bounding box location information indicating where the bounding boxes for detected objects are located in the images. Any 2D object detection model by the 2D object detector 520 may be used and examples of 2D object detectors 520 may include scale invariant feature transform (SIFT), you only look once (YOLO), single shot multibox detector (SSD), and the like. Of note, while shown using intermediate camera features 506 as input, it should be understood that the 2D object detector 520 may be trained to detect objects using, as input, the BEV projected camera features 508. In some cases, image segmentation may also be used.

In some cases, lidar data 510 may be received, for example as a lidar point cloud, captured by a lidar. Lidar may transmit a beam of ultraviolet, visible, or near infrared light into an environment and detects reflections of the beam from objects in the environment. Based on an amount of time needed for the reflections to be detected, distances to objects in the environment may be determined and lidar points may be described based on the point's location on a width, height, and depth axes with respect to the lidar. Thus, the lidar data is three-dimensional data. The lidar data 510 may be input to a lidar data encoder 512. The lidar data encoder 512 may be similar to the camera data encoder 504, but configured (e.g., trained) to operate in a 3D space to identify features in the lidar data and output the identified features as intermediate lidar features 514. The intermediate lidar features 514 may then be flattened 516 to BEV projected lidar features, for example, by removing or averaging the height information (e.g., height axes, height channel, height dimension).

In some cases, the intermediate lidar features 514 (e.g., 3D features) may be input to a 3D object detector 522 for object detection. In some cases, the 3D object detector 522 may be ML based on the 3D object detector 522 may locate and identify objects using the intermediate lidar features 514. Any 3D object detector 522 may be used and examples of 3D object detectors 522 may include Point Voxel-RCNN (PV-RCNN), VoxelNet, PointNet, PointNet++, etc. Of note, while shown using intermediate lidar features 514 as input, it should be understood that the 3D object detector 522 may be configured to detect objects using, as input, the flattened 516 BEV projected lidar features. For example, the 3D object detector 522 may detect and/or identify objects based on the intermediate lidar features 514 and place a bounding box around detected objects along with label(s) identifying the detected object. The 3D object detector 522 may output 3D bounding box location information indicating where the bounding boxes for detected objects are located in the 3D space described by the lidar data 510 along with the label(s).

In some cases, the output 3D bounding box location information and labels may be input to a 2D to 3D projector 524. In some cases, the intermediate lidar features 514 may also be input to the 2D to 3D projector 524, along with sensor calibration information. The 2D to 3D projector 524 may project the 3D bounding box(es) for detected object(s) into 2D from 3D to generate projected 2D bounding box information for output. The projection may be based on the sensor calibration information. For example, the sensor calibration information may include information such as camera intrinsic information (e.g., focal length, principal point, etc.), pose information for the sensors, and the like. The 2D to 3D projector 524 may determine transformation parameters, such as a rotation, translation, etc. based on the pose information (e.g., difference between a pose of a camera and a lidar) and along with the camera intrinsic information, and information about the lidar sensor to project the 3D bounding box location from 3D to 2D. In some cases, this projected 2D bounding box information may include location information indicating where the projected 2D bounding boxes for detected objects in the intermediate lidar features 514 would be located relative to an image of the input camera data 502.

In some cases, the projected 2D bounding box(es) from the projected 2D bounding box information may be aligned 526 with the bounding boxes for detected objects from the 2D object detector 520. Aligning the bounding boxes from 2D object detector 520 and 3D object detector 522 may be useful to assure accuracy in perception and decision making. In some cases, reliable alignments may rely on precise sensor calibrations (e.g., in the sensor calibration information) to ensure that data from the different sensors line up. In some cases, calibrating the sensors may be performed as a part of manufacturing a device.

In real world applications, maintaining a precise sensor calibration for multiple sensors on a device can be challenging. For example, devices with sensors may be vulnerable to sensor/calibration drift, sensor inaccuracy, noise, physically relocated sensors, and the like, which may result in unreliable 3D to 2D bounding box alignments between a projected 2D bounding box and a bounding box from 2D object detection, especially in complex environments. Thus, techniques for dynamically updating calibrations as between sensors may be useful.

In some cases, particle filtering for dynamic camera calibration optimization and variance-aware cross-attention may be useful for handling uncertainty when performing 3D to 2D bounding box alignments.

As indicated above, 3D bounding boxes may be transformed to projected 2D bounding boxes using a set of transformation parameters T (e.g., rotation R, translation t, etc.) and intrinsic parameters K (e.g., focal length f, principal point cx, cy, etc.). The transformation parameters T may represent a transformation that may be applied to a 3D bounding box (e.g., from the lidar data) to generate a corresponding projected 2D bounding box such that T=[R,t], where R may be rotation matrix, such as a 3×3 rotation matrix, and t may be a translation vector, such as a 3×1 translation vector. In some cases, the intrinsic parameters may be defined as K=fₓ, f_{y}, cₓ, c_{y}.

In some cases, a set of N particles may be initialized. In some cases, each particle of the set of N particles may be associated with a set of transformation parameters T and intrinsic parameters K (e.g., set of projection parameters). The set of projection parameters for each particle may be initialized with random parameter values. In some cases, the initialized random parameter values may be within certain reasonable bounds. Weights may be assigned to each particle. In some cases, equal weights, such as a default weight) may be assigned to each particle.

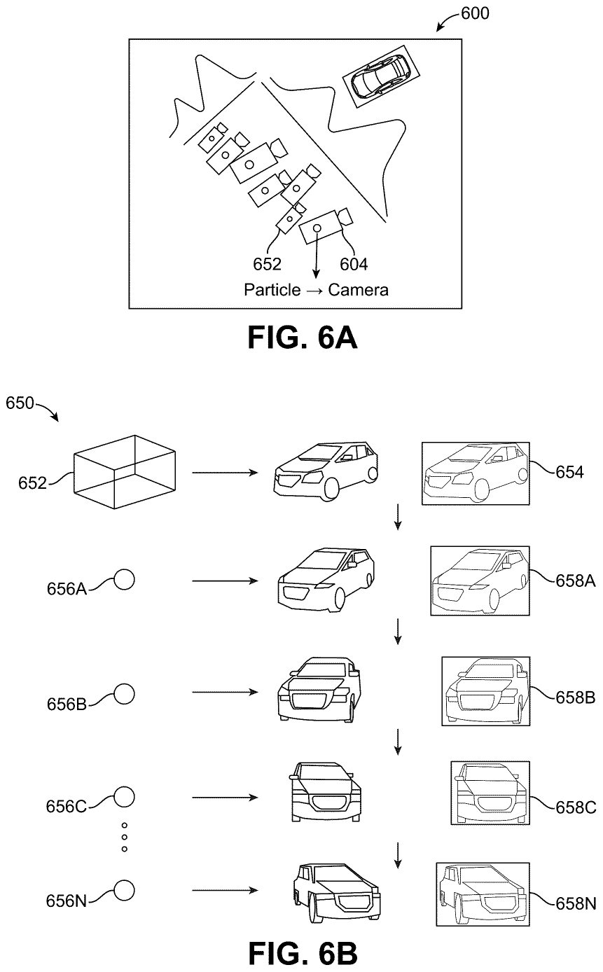

FIG. 6A illustrates examples of particles 600, in accordance with aspects of the present disclosure. In some cases, a set of particles may be initiated based on a 3D bounding box and corresponding bounding box from 2D object detection (e.g., based on output from the 3D object detector 522 and 2D object detector 520 of FIG. 5). As indicated above, each particle may be initialized with random parameter values and each particle may represent a hypothesis for a set of projection parameters for projecting a 3D bounding box to the 2D dimensions.

In some cases, random perturbation (e.g., noise) may be applied to the set of projection parameters of each particle. The random perturbation may have an effect of allowing each particle to represent different transformation parameters and different intrinsic parameters. The random set of projection parameters allow the particles to act as different cameras and/or camera locations. Thus, a first particle 602 may represent a first camera type (e.g., based on the intrinsic parameters) with a first location (e.g., based on the transformation parameters) as compared to a second particle 604. The random perturbation may be applied such that the perturbations fall within defined ranges for the parameters. These defined ranges may be based on expected reasonable camera calibrations.

FIG. 6B illustrates an example of interactions 650 between bounding boxes and particles, in accordance with aspects of the present disclosure. As an example, a first 3D bounding box 652 may be projected based on an original set of projection parameters (e.g., from sensor calibration information) in the to the first 2D bounding box 654. The set of projection parameters associated with each of the particles 656A, . . . 656N (collectively “particles 656”) may be used to project a 3D bounding box, such as the 3D bounding box 652, to a 2D bounding box for a 2D image. For example, a first particle 656A may be initialized, for example, with a set of projection parameters that projects the 3D bounding box 652 to a first projected 2D bounding box candidate 658A. Similarly, a second particle 656B may be initialized with a set of projection parameters that projects the 3D bounding box 652 to a second projected 2D bounding box candidate 658B, a third particle 656C may be initialized with a set of projection parameters that projects the 3D bounding box 652 to a third projected 2D bounding box candidate 658C, through a Nth particle 656N, which may be initialized with a set of projection parameters that projects the 3D bounding box 652 to a Nth projected 2D bounding box candidate 658N.

In some cases, the 3D bounding box may be projected to 2D using the intrinsic parameters K and transformations T associated with a particle. The projection may be done such that p=K·[R|t]·P3D, T=[R|t], where K is the camera intrinsic matrix, R is the rotation matrix, t is the translation vector, P3D is a 3D point from the bounding box, and p is a projected 2D point. The projected 2D points for each particle may be compared to 2D points associated with a 2D bounding box of an object (e.g., as detected by the 2D object detector 520 of FIG. 5). For each particle, a projection error (e.g., loss) is determined by comparing the projected 2D points from the 3D bounding box to the 2D bounding box in the image. In some cases, an error function, such as an intersection over union (IoU) (or another distance metric, such as L1/L2 norm loss, Huber loss, projection error based on edges, etc.) may be used to determine the projection error based on how well the projected 2D points of the 3D bounding box for a particle match with the points of the 2D bounding box in an image. The particle weight associated with each particle may be updated based on the projection error for a particle. For example, particles with lower projection error may be updated with higher weights, while particles that have a higher projection error may be updated with lower weights.

After the particle weights have been updated, resampling may be performed. For resampling, particles associated with higher weights may be kept as these particles may project the 3D bounding box to a projected 2D bounding box that is better aligned (e.g., are associated with set of projection parameters that are more closely aligned) with the actual 2D bounding box. In some cases, the particle weights may be compared to a threshold weight to determine which particles may be retained. The retained particles may be used for a next iteration of the particle filter.

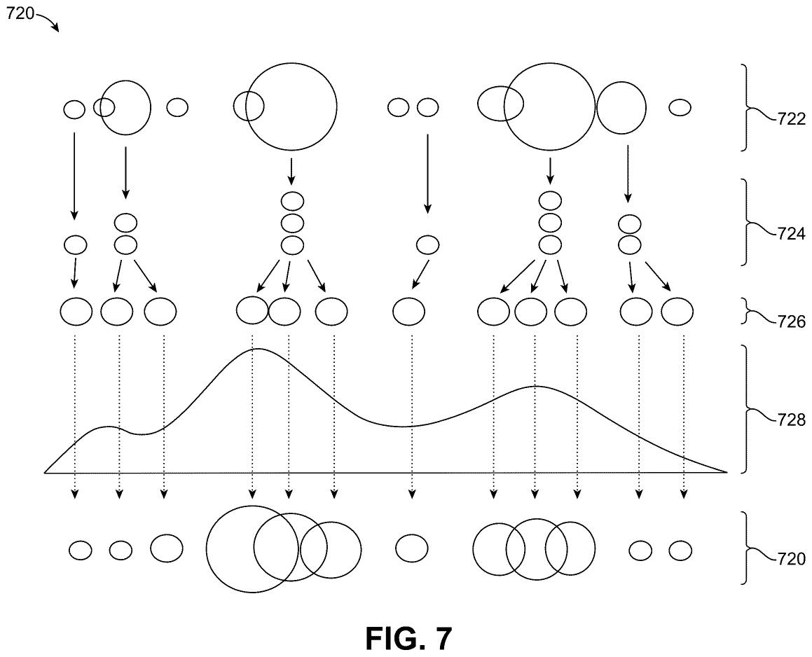

FIG. 7 illustrates an example of particle filtering 720, in accordance with aspects of the present disclosure. In some cases, a 3D point, such as a 3D point from the bounding box, may be projected to a 2D space of an image (e.g., as captured by one or more cameras of the device) as a 2D point using the set of projection parameters of a particle. A weight associated with the particle may indicate how likely a projected 2D point is to match an actual 2D point. This weight may be represented as a circle. As indicated above, particles associated with higher weights may be retained and these retained particles 722 are shown in FIG. 7 as circles with a size based on the weight associated with the respective retained particles 722. For example, retained particles 722 associated with more weight may appear larger than retained particles associated with less weight (e.g., but above the threshold weight).

Particles associated with lower weights, such as those weights which do not meet the threshold weight, may be resampled and resampled particles 724 generated. In some cases, the particles associated with lower weights may be discarded and new particles may be generated with resampled set of transformation parameters, intrinsic parameters, and default weights to generate the resampled particles 724. In other cases, the particles associated with lower weights may be reassociated with a resampled set of transformation parameters, intrinsic parameters, and default weights to generate the resampled particles 724. In some cases, resampled particles 724 may have a resampled set of projection parameters based on the set of projection parameters of the retained particles 722. In some cases, multiple resampled particles 724 may be generated based on a single retained particle and the number of resampled particles 724 generated based on a retained particle may be based of the weight associated with the retained particle. For example, more resampled particles 724 may be generated based on a retained particle associated with a higher wight and less resampled particles 724 may be generated based on a retained particle associated with a lower wight.

As indicated above, in some cases, random perturbation (e.g., noise) may be added 726 to the set of projection parameters of the particles. As discussed above, the particles may be used to project a 3D bounding box (e.g., first 3D bounding box 652) to 2D for comparison with a 2D bounding box from a 2D image (e.g., first 2D bounding box 654) to determine a projection error for each particle to measure 708 how well a projected 2D bounding box projected using the set of projection parameters of each particle match with the actual 2D bounding box in an image. As discussed above, the particle weights associated with each particle may be updated 730 based on the projection error for a particle. The particles with updated 730 weights may be resampled to generate resampled particles 724 for a next iteration through the particle filter.

This process of generating resampled particles 724, adding 726 noise, measuring 728, and updating 730 weights may be repeated for a predefined number of iterations or until there is a convergence (when less than a threshold amount of change in particle distribution (e.g., when the set of projection parameters of the different particles have less then a threshold amount of difference)). In some cases, a filtered estimate of the set of projection parameters (e.g., for the sensor calibration information) may be a weighted average of the best particles (e.g., particles associated with the highest weight). The filtered estimated set of projection parameters may be output by the particle filter for use to align projected 2D bounding boxes with 2D bounding boxes.

In some cases, the particle filter may also output an uncertainty associated with the final estimated transformation parameters and intrinsic parameters. This uncertainty may be based on a weighted average of the weights of the best particles (e.g., particles used to determine output parameters). The output uncertainty may represent a variance in the filtered estimated set of projection parameters for projecting the 3D bounding box to a 2D image plane. Variance may be a statistical representation of uncertainty in any random variable, where a higher the variance, the higher the uncertainty. In some cases, the filtered estimated set of projection parameters and the output uncertainty may be passed into a variance-aware cross attention mechanism (e.g., one or more cross attention layers and other related layers of a ML model) to model the projection of the 3D bounding box (or 3D point(s)) to the 2D image plane as a distribution (e.g., mean with variance) rather than a deterministic bounding box/point to capture projection uncertainty. The variance may be used as an input to the attention to give higher weight to the points which are projected with higher confidence (lower variance/uncertainty).

In some cases, the cross-attention mechanism may receive, as input, a set of 3D points corresponding to the 3D bounding box, information about 2D projected points (e.g., from a projection of the 3D points based on the filtered estimated set of projection parameters for a particle), along with uncertainty information, and the filtered estimated set of projection parameters from the particle filter. The cross-attention mechanism may output, for example, the set of 2D projected points (e.g., corresponding to the 3D bounding box) along with a distribution for 2D projected points of the set of 2D projected points. The distribution may be, for example, a probabilistic mapping of 3D points or an attention weighted 2D projections.

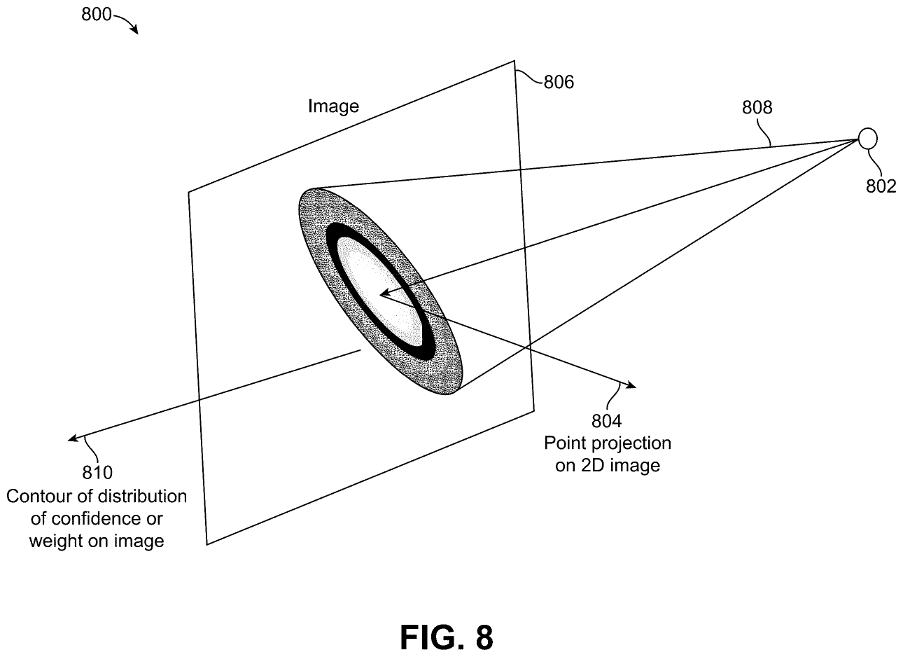

FIG. 8 illustrates an example of a distribution for a 2D projected point 800, in accordance with aspects of the present disclosure. As shown in FIG. 8, a 3D point 802 (e.g., corresponding to the 3D bounding box) may be projected to 2D as a projected 2D point 804 on an image 806. The output uncertainty 808 may indicate an extent in which an actual 2D point (e.g., determined from the 2D image) may be located. In some cases, the cross-attention mechanism may determine a distribution 810 (e.g., mean with variance) based on the uncertainty 808 and the projection. In some cases, the distribution 810 may represent a probabilistic mapping of the 3D points or an attention weighted 2D projection.

In some cases, the 3D points from the 3D bounding box may be used as queries and the possible projections to 2D points (e.g., from the final estimated transformation parameters and intrinsic parameters) may be used as keys and values for the cross-attention. The 3D point may be represented as queries in the attention mechanism and each 3D point may operate as a query to the 2D projection asking for a 2D point (e.g., location) in the image corresponding to the 3D point. The projections to 2D points and associated variances may act as keys which represent possible 2D locations where a 3D point may be projected, and the variance may indicate an uncertainty of the projection. The projections to 2D may also act as values in the attention network as the projected 2D points in the image space and the attention network may learn to use the uncertainty to weigh the contributions for the possible projections. As an example, cross-attention may act as a retrieval process based on a weighted average of values mapping the query against the keys to generate a best value. The 3D points (queries) may be mapped to the possible projected 2D points using the filtered estimated set of projection parameters and the variance may be used to model uncertainty (e.g., create a distribution) for the projection. In some cases, a Gaussian distribution around the mean projected 2D point may be assumed and a spread around the mean projected 2D point based on the variance. Thus, the mean may represent a center of the projection (e.g., projected 2D point), and the variance accounts for the uncertainty.

The cross-attention mechanism (e.g., cross-attention network) may assign higher weights to projections with a lower variance and thus giving more reliable projections more influence in the final mapping. The cross-attention network may learn how to probabilistically map 3D points to their corresponding projected 2D points and refine help refine their alignment by emphasizing projections with lower uncertainty (e.g., those with a smaller variance).

In some cases, cross-attention between the 3D points (e.g., as queries) and the 2D projections (e.g., as keys and values) allows the cross-attention network to learn mappings between different modalities, such as 3D points and projections to 2D points, while accounting for uncertainty. For example, for a set of 3D points, attention weights may be determined based on how well each 3D point aligns with a 2D projection, factoring in the uncertainty from the variance. In some cases, the attention weights for the 3D points (e.g., as queries) and 2D projection (e.g., as keys) may be determined as:

$$Attention ( Q , K , V ) = softmax ( \frac{Q {K}^{T}}{\sqrt{{d}_{k}}} ) V ,$$

where Q represent a query matrix, K represent a key matrix, V represent a value matrix, and dk represent a dimensionality of key vectors (e.g., in the key matrix). The cross-attention may aggregate information from the 2D projection distribution for each 3D point. In some cases, the variance of the 2D projections may influence the similarity score between a 3D point and its 2D projection. To incorporate the variance of the 2D projection into the similarity score, the attention mechanism may be modified to give lower weights to projections with a higher variance (e.g., less confident projections). The attention score may be modified such that

$$AttentionScore = \frac{Q {K}^{T}}{\sqrt{{d}_{k}} * {σ}_{2 D}} ,$$

where σ_{2D} may be an variance (e.g., uncertainty) of the 2D projection. The larger variance may then lead to a lower attention score and reduce the attention weight for the corresponding projection.

The attention mechanism may determine how well each 3D point corresponds to the 2D projection, factoring in the variance from the projection and output a weighted sum of the 2D projections as the 2D projection along with an uncertainty value represent the most likely projection locations for the 3D points. By taking into account the variance for 2D projections from 3D points, a projection of 3D points may be modeled as a distribution in 2D space. This distribution may capture uncertainty and be used to improve robustness of a 3D-to-2D projection to help make more reliable bounding box alignments and improve performance for sensor fusion tasks, which may rely on well calibrated sensor alignments. The output 2D projection (e.g., transformation parameters and intrinsic parameters) and uncertainty value from the cross-attention mechanism may be used to update sensor calibration information for projecting 3D points (e.g., from a 3D bounding box) from a first sensor, such as a lidar to projected 2D points for alignment with 2D points (e.g., of a 2D bounding box) generated based on 2D data from a second sensor, such as a camera.

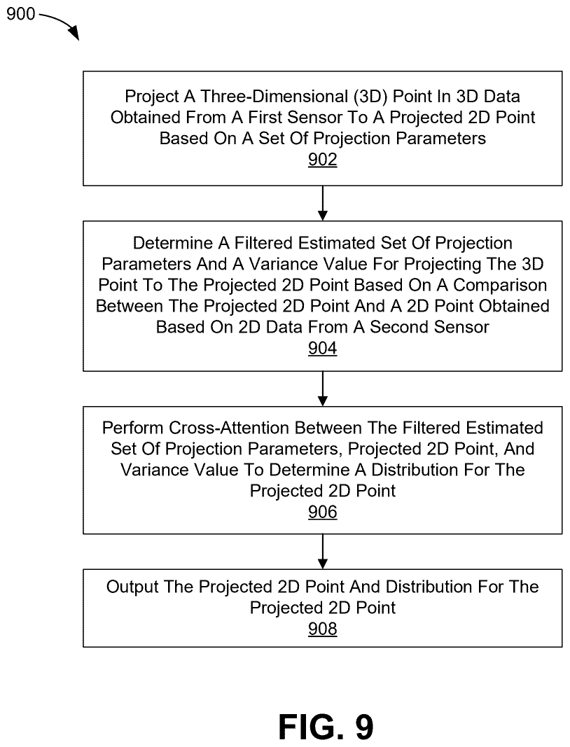

FIG. 9 is a flow diagram illustrating a process 900 for 3D to 2D projection, in accordance with aspects of the present disclosure. The process 900 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. In some cases, the computing device may be or may include coding device, such as an encoding device, decoding device, or a combined encoding device (or codec). The operations of the process 900 may be implemented as software components that are executed and run on one or more processors (such as CPU 102, GPU 104, DSP 106, NPU 108 of FIG. 1, processor 1010 of FIG. 10, etc.).

At block 902, the computing device (or component thereof) may project a three-dimensional (3D) point (e.g., a 3D point 802 of FIG. 8) in 3D data (e.g., lidar data 510 of FIG. 5) obtained from a first sensor (e.g., lidar sensor, radar sensor, etc.) to a projected 2D point (e.g., projected 2D point 804 of FIG. 8) based on a set of projection parameters. In some cases, the set of projection parameters comprises a set of transformation parameters and camera intrinsic parameters. In some examples, the 3D point comprises a 3D point of a 3D bounding box (e.g., 3D bounding box 652 of FIG. 6), and wherein the 2D point comprises a 2D point of a 2D bounding box (e.g., 2D bounding box 654 of FIG. 6).

At block 904, the computing device (or component thereof) may determine a filtered (e.g., via particle filtering 720 of FIG. 7) estimated set of projection parameters and a variance value for projecting the 3D point to the projected 2D point based on a comparison between the projected 2D point and a 2D point obtained based on 2D data (e.g., input camera data 502 of FIG. 5) from a second sensor (e.g., a camera). In some cases, the first sensor comprises a lidar sensor and wherein the second sensor comprises a camera. In some examples, the comparison between the projected 2D point to the 2D point obtained based on the 2D data from the second sensor comprises comparing the projected 2D point to the 2D point obtained based on 2D data from the second sensor to determine a projection error for updating a weight associated with the set of projection parameters. For example, a projection error may be determined by comparing the projected 2D points from the 3D bounding box to the 2D bounding box in the image. In some cases, the computing device (or component thereof) may resample the set of projection parameters (e.g., as resampled particles 724 of FIG. 7) based on the weight to determine the filtered estimated set of projection parameters and the variance value. In some examples, the projection error comprises an intersection over union (IoU) between the projected 2D point and the 2D point obtained based on 2D data. For example, the IoU, or another distance metric, may be used to determine the projection error based on how well the projected 2D points of the 3D bounding box for a particle match with the points of the 2D bounding box in an image. In some cases, the computing device (or component thereof) may to generate a set of particles, wherein a particle (e.g., first particle 602 of FIG. 6, second particle 604 of FIG. 6, particles 656 of FIG. 6, etc.), of a set of particles, represents the set of projection parameters. In some examples, the computing device (or component thereof) resample the set of projection parameters based on the weight by determining to resample the set of projection parameters based on a second particle, of the set of particles. In some cases, a second weight associated with the second particle is larger as compared to the weight associated with the set of projection parameters. In some cases, the computing device (or component thereof) may randomly perturb (e.g., random perturbation (e.g., noise) may be added 726 of FIG. 7) parameters of the set of projection parameters.

At block 906, the computing device (or component thereof) may perform cross-attention between the filtered estimated set of projection parameters, projected 2D point, and variance value to determine a distribution (e.g., distribution 810 of FIG. 8) for the projected 2D point. In some cases, the computing device (or component thereof) may perform the cross-attention based on a Gaussian distribution around the projected 2D point based on the variance value. For example, a Gaussian distribution around the mean projected 2D point may be assumed and a spread around the mean projected 2D point based on the variance. In some examples, the cross-attention weighs the projected 2D point based on the variance value.

At block 908, the computing device (or component thereof) may output the projected 2D point and distribution for the projected 2D point.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 900 and/or other processes described herein may include a processor, microprocessor, micro-computer, or other component of a device that is configured to carry out the steps of the process 900 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 900 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 900 is illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 900 and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 10 illustrates an example computing device architecture 1000 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. The components of computing device architecture 1000 are shown in electrical communication with each other using connection 1005, such as a bus. The example computing device architecture 1000 includes a processing unit (CPU or processor) 1010 and computing device connection 1005 that couples various computing device components including computing device memory 1015, such as read only memory (ROM) 1020 and random access memory (RAM) 1025, to processor 1010.

Computing device architecture 1000 can include a cache of high-speed memory connected directly with, in close proximity to, or integrated as part of processor 1010. Computing device architecture 1000 can copy data from memory 1015 and/or the storage device 1030 to cache 1012 for quick access by processor 1010. In this way, the cache can provide a performance boost that avoids processor 1010 delays while waiting for data. These and other modules can control or be configured to control processor 1010 to perform various actions. Other computing device memory 1015 may be available for use as well. Memory 1015 can include multiple different types of memory with different performance characteristics. Processor 1010 can include any general purpose processor and a hardware or software service, such as service 1 1032, service 2 1034, and service 3 1036 stored in storage device 1030, configured to control processor 1010 as well as a special-purpose processor where software instructions are incorporated into the processor design. Processor 1010 may be a self-contained system, containing multiple cores or processors, a bus, memory controller, cache, etc. A multi-core processor may be symmetric or asymmetric.

To enable user interaction with the computing device architecture 1000, input device 1045 can represent any number of input mechanisms, such as a microphone for speech, a touch-sensitive screen for gesture or graphical input, keyboard, mouse, motion input, speech and so forth. Output device 1035 can also be one or more of a number of output mechanisms known to those of skill in the art, such as a display, projector, television, speaker device, etc. In some instances, multimodal computing devices can enable a user to provide multiple types of input to communicate with computing device architecture 1000. Communication interface 1040 can generally govern and manage the user input and computing device output. There is no restriction on operating on any particular hardware arrangement and therefore the basic features here may easily be substituted for improved hardware or firmware arrangements as they are developed.

Storage device 1030 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1025, read only memory (ROM) 1020, and hybrids thereof. Storage device 1030 can include services 1032, 1034, 1036 for controlling processor 1010. Other hardware or software modules are contemplated. Storage device 1030 can be connected to the computing device connection 1005. In one aspect, a hardware module that performs a particular function can include the software component stored in a computer-readable medium in connection with the necessary hardware components, such as processor 1010, connection 1005, output device 1035, and so forth, to carry out the function.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors, and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific embodiments. For example, a system may be implemented on one or more printed circuit boards or other substrates, and may have movable or static components. While the below description and examples use the term “system” to describe various aspects of this disclosure, the term “system” is not limited to a specific configuration, type, or number of objects.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as flash memory, memory or memory devices, magnetic or optical disks, flash memory, USB devices provided with non-volatile memory, networked storage devices, compact disk (CD) or digital versatile disk (DVD), any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors or other suitable electronic circuits) to perform the operation, or any combination thereof.

The phrase “coupled to” refers to any component that is physically connected to another component either directly or indirectly and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. An apparatus for three-dimensional (3D) to two-dimensional (2D) alignment, comprising: at least one memory; and at least one processor coupled to the at least one memory and configured to: project a 3D point in 3D data obtained from a first sensor to a projected 2D point based on a set of projection parameters; determine a filtered estimated set of projection parameters and a variance value for projecting the 3D point to the projected 2D point based on a comparison between the projected 2D point and a 2D point obtained based on 2D data from a second sensor; perform cross-attention between the filtered estimated set of projection parameters, projected 2D point, and variance value to determine a distribution for the projected 2D point; and output the projected 2D point and distribution for the projected 2D point.
Aspect 2. The apparatus of Aspect 1, wherein the set of projection parameters comprises a set of transformation parameters and camera intrinsic parameters.
Aspect 3. The apparatus of any of Aspects 1-2, wherein the first sensor comprises a lidar sensor and wherein the second sensor comprises a camera.
Aspect 4. The apparatus of any of Aspects 1-3, wherein the 3D point comprises a 3D point of a 3D bounding box, and wherein the 2D point comprises a 2D point of a 2D bounding box.
Aspect 5. The apparatus of any of Aspects 1-4, wherein the comparison between the projected 2D point to the 2D point obtained based on the 2D data from the second sensor comprises comparing the projected 2D point to the 2D point obtained based on 2D data from the second sensor to determine a projection error for updating a weight associated with the set of projection parameters.
Aspect 6. The apparatus of Aspect 5, wherein the at least one processor is further configured to resample the set of projection parameters based on the weight to determine the filtered estimated set of projection parameters and the variance value.
Aspect 7. The apparatus of any of Aspects 5-6, wherein the projection error comprises an intersection over union between the projected 2D point and the 2D point obtained based on 2D data.
Aspect 8. The apparatus of any of Aspects 5-7, wherein the at least one processor is configured to generate a set of particles, wherein a particle, of a set of particles, represents the set of projection parameters.
Aspect 9. The apparatus of Aspect 8, wherein, to resample the set of projection parameters based on the weight, the at least one processor is configured to determine to resample the set of projection parameters based on a second particle, of the set of particles, wherein a second weight associated with the second particle is larger as compared to the weight associated with the set of projection parameters.
Aspect 10. The apparatus of any of Aspects 1-9, wherein the at least one processor is configured to randomly perturb parameters of the set of projection parameters.
Aspect 11. The apparatus of any of Aspects 1-10, wherein the at least one processor is configured to perform the cross-attention based on a Gaussian distribution around the projected 2D point based on the variance value.
Aspect 12. The apparatus of any of Aspects 1-11, wherein the cross-attention weighs the projected 2D point based on the variance value.
Aspect 13. A method for three-dimensional (3D) to two-dimensional (2D) alignment, comprising: projecting a 3D point in 3D data obtained from a first sensor to a projected 2D point based on a set of projection parameters; determining a filtered estimated set of projection parameters and a variance value for projecting the 3D point to the projected 2D point based on a comparison between the projected 2D point and a 2D point obtained based on 2D data from a second sensor; performing cross-attention between the filtered estimated set of projection parameters, projected 2D point, and variance value to determine a distribution for the projected 2D point; and outputting the projected 2D point and distribution for the projected 2D point.
Aspect 14. The method of Aspect 13, wherein the set of projection parameters comprises a set of transformation parameters and camera intrinsic parameters.
Aspect 15. The method of any of Aspects 13-14, wherein the first sensor comprises a lidar sensor and wherein the second sensor comprises a camera.
Aspect 16. The method of any of Aspects 13-15, wherein the 3D point comprises a 3D point of a 3D bounding box, and wherein the 2D point comprises a 2D point of a 2D bounding box.
Aspect 17. The method of any of Aspects 13-16, wherein the comparison between the projected 2D point to the 2D point obtained based on the 2D data from the second sensor comprises comparing the projected 2D point to the 2D point obtained based on 2D data from the second sensor to determine a projection error for updating a weight associated with the set of projection parameters.
Aspect 18. The method of Aspect 17, further comprising resampling the set of projection parameters based on the weight to determine the filtered estimated set of projection parameters and the variance value.
Aspect 19. The method of any of Aspects 17-18, wherein the projection error comprises an intersection over union between the projected 2D point and the 2D point obtained based on 2D data.
Aspect 20. The method of any of Aspects 17-19, further comprising generating a set of particles, wherein a particle, of a set of particles, represents the set of projection parameters.
Aspect 21. The method of Aspect 20, wherein resampling the set of projection parameters based on the weight comprises determining to resample the set of projection parameters based on a second particle, of the set of particles, wherein a second weight associated with the second particle is larger as compared to the weight associated with the set of projection parameters.
Aspect 22. The method of any of Aspects 13-21, further comprising randomly perturbing parameters of the set of projection parameters.
Aspect 23. The method of any of Aspects 13-22, further comprising performing the cross-attention based on a Gaussian distribution around the projected 2D point based on the variance value.
Aspect 24. The method of any of Aspects 13-23, wherein the cross-attention weighs the projected 2D point based on the variance value.
Aspect 25: An apparatus for three-dimensional (3D) to two-dimensional (2D) alignment, comprising one or more means for performing any of the operations of Aspects 13 to 24.
Aspect 26. A non-transitory computer-readable medium having stored thereon instructions that, when executed by at least one processor, cause the at least one processor to perform any of the operations of Aspects 13-24.

What is claimed is:

1. An apparatus for three-dimensional (3D) to two-dimensional (2D) alignment, comprising:
at least one memory; and
at least one processor coupled to the at least one memory and configured to:
project a 3D point in 3D data obtained from a first sensor to a projected 2D point based on a set of projection parameters;
determine a filtered estimated set of projection parameters and a variance value for projecting the 3D point to the projected 2D point based on a comparison between the projected 2D point and a 2D point obtained based on 2D data from a second sensor;
perform cross-attention between the filtered estimated set of projection parameters, projected 2D point, and variance value to determine a distribution for the projected 2D point; and
output the projected 2D point and distribution for the projected 2D point.

2. The apparatus of claim 1, wherein the set of projection parameters comprises a set of transformation parameters and camera intrinsic parameters.

3. The apparatus of claim 1, wherein the first sensor comprises a lidar sensor and wherein the second sensor comprises a camera.

4. The apparatus of claim 1, wherein the 3D point comprises a 3D point of a 3D bounding box, and wherein the 2D point comprises a 2D point of a 2D bounding box.

5. The apparatus of claim 1, wherein the comparison between the projected 2D point to the 2D point obtained based on the 2D data from the second sensor comprises comparing the projected 2D point to the 2D point obtained based on 2D data from the second sensor to determine a projection error for updating a weight associated with the set of projection parameters.

6. The apparatus of claim 5, wherein the at least one processor is further configured to resample the set of projection parameters based on the weight to determine the filtered estimated set of projection parameters and the variance value.

7. The apparatus of claim 5, wherein the projection error comprises an intersection over union between the projected 2D point and the 2D point obtained based on 2D data.

8. The apparatus of claim 5, wherein the at least one processor is configured to generate a set of particles, wherein a particle, of a set of particles, represents the set of projection parameters.

9. The apparatus of claim 8, wherein, to resample the set of projection parameters based on the weight, the at least one processor is configured to determine to resample the set of projection parameters based on a second particle, of the set of particles, wherein a second weight associated with the second particle is larger as compared to the weight associated with the set of projection parameters.

10. The apparatus of claim 1, wherein the at least one processor is configured to randomly perturb parameters of the set of projection parameters.

11. The apparatus of claim 1, wherein the at least one processor is configured to perform the cross-attention based on a Gaussian distribution around the projected 2D point based on the variance value.

12. The apparatus of claim 1, wherein the cross-attention weighs the projected 2D point based on the variance value.

13. A method for three-dimensional (3D) to two-dimensional (2D) alignment, comprising:
projecting a 3D point in 3D data obtained from a first sensor to a projected 2D point based on a set of projection parameters;
determining a filtered estimated set of projection parameters and a variance value for projecting the 3D point to the projected 2D point based on a comparison between the projected 2D point and a 2D point obtained based on 2D data from a second sensor;
performing cross-attention between the filtered estimated set of projection parameters, projected 2D point, and variance value to determine a distribution for the projected 2D point; and
outputting the projected 2D point and distribution for the projected 2D point.

14. The method of claim 13, wherein the set of projection parameters comprises a set of transformation parameters and camera intrinsic parameters.

15. The method of claim 13, wherein the first sensor comprises a lidar sensor and wherein the second sensor comprises a camera.

16. The method of claim 13, wherein the 3D point comprises a 3D point of a 3D bounding box, and wherein the 2D point comprises a 2D point of a 2D bounding box.

17. The method of claim 13, wherein the comparison between the projected 2D point to the 2D point obtained based on the 2D data from the second sensor comprises comparing the projected 2D point to the 2D point obtained based on 2D data from the second sensor to determine a projection error for updating a weight associated with the set of projection parameters.

18. The method of claim 17, further comprising resampling the set of projection parameters based on the weight to determine the filtered estimated set of projection parameters and the variance value.

19. The method of claim 17, wherein the projection error comprises an intersection over union between the projected 2D point and the 2D point obtained based on 2D data.

20. The method of claim 17, further comprising generating a set of particles, wherein a particle, of a set of particles, represents the set of projection parameters.
